(19) United States
(12) Patent Application Publication
(10) Pub. No.: US 2026/0023238 A1
(43) Pub. Date: Jan. 22, 2026

(54) OPTICAL ELEMENT DRIVING MECHANISM

(71) Applicant: TDK TAIWAN CORP., Taoyuan City (TW)

(72) Inventors: Chuan-Min LEE, Taoyuan City (TW); Chao-Chang HU, Taoyuan City (TW); Shu-Shan CHEN, Taoyuan City (TW); Pai-Jui CHENG, Taoyuan City (TW)

(21) Appl. No.: 18/777,959

(22) Filed: Jul. 19, 2024

(51) Int. Cl. G02B 7/00; G02B 13/00; G03B 13/36; H04N 23/51; H04N 23/68

(52) U.S. Cl. CPC G02B 7/005; G02B 13/001; G03B 13/36; H04N 23/51; H04N 23/685; G03B 2205/0061

(57) ABSTRACT

An optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

### BACKGROUND OF THE INVENTION

### Field of the Disclosure

The present disclosure relates to an optical element driving mechanism, and in particular it relates to an optical element driving mechanism with a piezoelectric element.

### Description of the Related Art

As technology has developed, many of today's electronic devices (such as smartphones) have been equipped with cameras to provide photographic and video functionality. Users can capture photographs and record videos using the camera modules disposed in their electronic devices.

Today's design of electronic devices continues to follow the trend of miniaturization, meaning that the various components of the camera module and its structure must also be continuously reduced, so as to achieve miniaturization. In general, a driving mechanism in a camera module has a camera lens holder configured to hold a camera lens, and the driving mechanism can have the functions of auto focusing or optical image stabilization. However, although existing driving mechanisms can achieve the aforementioned functions of taking photographs and recording videos, they still cannot meet all users' needs.

Therefore, how to design a camera module that can perform autofocus and optical anti-shake functions while achieving miniaturization at the same time is a topic nowadays that needs to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

According to some embodiments, the optical element driving mechanism further includes a first guiding assembly configured to guide the movement of the movable part relative to the fixed assembly. The first guiding assembly includes a first stabilizing element, a first supporting element and a first corresponding element. The first stabilizing element has a magnetic material. The first supporting element has a magnetically conductive material. The first stabilizing element is configured to generate a first stabilizing force to the movable part. The first stabilizing force drives the movable part toward the first supporting element.

According to some embodiments, the first corresponding element has a first accommodation space configured to accommodate at least a portion of the first supporting element. The first corresponding element further includes a first contact portion configured to contact the first supporting element. The first supporting element has a long strip-shaped structure. The first supporting element extends along a first axis. When viewed along the first axis, the center of the first supporting element does not overlap the center of the first accommodation space.

According to some embodiments, when viewed along the first axis, the minimum distance between a close portion of the first accommodation space and the first supporting element is less than the minimum distance between an avoiding portion of the first accommodation space and the first supporting element. When viewed along the first axis, the close portion and the avoiding portion define a first imaginary line which passes through the close portion and the avoiding portion. The first imaginary line is parallel to the first stabilizing force. When viewed along the first axis, the first accommodation space has a long strip-shaped structure. When viewed along the first axis, the extending direction of the first accommodation space is parallel to the first stabilizing force.

According to some embodiments, the first corresponding element further includes a second accommodation space configured to accommodate at least a portion of the first supporting element. The first accommodation space and the second accommodation space are arranged along the first axis. The first corresponding element further has a second contact portion configured to contact the first supporting element. The first contact portion and the second contact portion are arranged along the first axis. The first corresponding element further has a first separating portion located between the first accommodation space and the second accommodation space. The first separating portion is located between the first contact portion and the second contact portion. The first separating portion does not contact the first supporting element.

According to some embodiments, the optical element driving mechanism further includes a second guiding assembly configured to guide the movement of the movable part relative to the fixed assembly. The second guiding assembly includes a second supporting element and a second corresponding element. The second corresponding element has a third accommodation space configured to accommodate at least a portion of the second supporting element. The second corresponding element has a third contact portion configured to contact the second supporting element. The second supporting element has a long strip-shaped structure. The second supporting element extends along the first axis.

According to some embodiments, the second corresponding element further includes a fourth accommodation space configured to accommodate at least a portion of the second supporting element. The third accommodation space and the fourth accommodation space are arranged along the first axis.

According to some embodiments, the second corresponding element further has a fourth contact portion configured to contact the second supporting element. The third contact portion and the fourth contact portion are arranged along the first axis. The second corresponding element further has a second separating portion located between the third accommodation space and the fourth accommodation space. The second separating portion is located between the third contact portion and the fourth contact portion. The second separating portion does not contact the second supporting element. The shortest distance between the first accommodation space and the second accommodation space is different from the shortest distance between the third accommodation space and the fourth accommodation space. The shortest distance between the first accommodation space and the second accommodation space is less than the shortest distance between the third accommodation space and the fourth accommodation space.

According to some embodiments, when viewed along the first axis, the shortest distance between the center of the first supporting element and the center of the optical element is different from the shortest distance between the center of the second supporting element and the center of the optical element. When viewed along the first axis, the shortest distance between the center of the first supporting element and the center of the optical element is greater than the shortest distance between the center of the second supporting element and the center of the optical element.

According to some embodiments, when viewed in a direction perpendicular to the first axis, at least a portion of the first accommodation space overlaps the third accommodation space. When viewed in a direction perpendicular to the first axis, the second accommodation space does not overlap the fourth accommodation space.

According to some embodiments, the fixed assembly includes a casing and a base. The casing has a top wall and a side wall. The top wall is connected to the side wall. The top wall has a plate-shaped structure which is not parallel to the first axis. The first accommodation space is closer to the top wall than the second accommodation space. The third accommodation space is closer to the top wall than the fourth accommodation space.

According to some embodiments, the second corresponding element has a protruding portion which extends toward the base. The base has a plastic material. The fourth accommodation space is located at the protruding portion. The first corresponding element and the second corresponding element are integrally formed as one piece. The first stabilizing element is fixedly connected to the movable part. The first supporting element is fixedly connected to the fixed assembly. The second supporting element is fixedly connected to the fixed assembly.

According to some embodiments, the driving assembly includes a driving element, a transmission element and an enhancing element. The driving element is fixedly connected between the transmission element and the enhancing element. The driving element is configured to generate a driving force. The driving element has a piezoelectric unit. The transmission element is configured to transmit the driving force. The enhancing element is configured to enhance the driving force. The transmission element has a long strip-shaped structure which extends along the main axis.

According to some embodiments, the optical element driving mechanism further includes a central assembly, and the driving force is transmitted to the movable part through the central assembly. The central assembly includes a clamping member and a contact assembly. The clamping member is configured to apply a first clamping force and a second clamping force to the transmission element. At least a portion of the contact assembly is located between the clamping member and the transmission element. The clamping member applies the first clamping force and the second clamping force to the contact assembly. Directions of the first clamping force and the second clamping force are different.

According to some embodiments, when the center of the transmission element is defined as the origin, the angle between the first clamping force or the second clamping force and the first stabilizing force exceeds 90 degrees. When viewed along the main axis, a connecting line between the center of the first supporting element and the center of the transmission element passes through the optical element. The first stabilizing force is a non-contact force. The first clamping force and the second clamping force belong to mechanical forces.

According to some embodiments, when viewed along the main axis, a connecting line between the center of the second supporting element and the center of the transmission element does not pass through the optical element. When viewed along the main axis, a connecting line between the center of the first supporting element and the center of the second supporting element passes through the optical element. When viewed along the first axis, the first accommodation space has a long strip-shaped structure which extends along a second axis. The optical element driving mechanism further defines a third axis. The third axis, the first axis and the second axis are perpendicular to each other. When viewed along the first axis, the first stabilizing element and the first supporting element are arranged along the second axis.

According to some embodiments, when viewed along the first axis, the maximum size of the first accommodation space on the second axis and the maximum size of the first accommodation space on the third axis have a first ratio. When viewed along the first axis, the maximum size of the third accommodation space on the second axis and the maximum size of the third accommodation space on the third axis have a second ratio. The first ratio is different from the second ratio. The first ratio is greater than the second ratio.

According to some embodiments, the optical element driving mechanism further includes a position-sensing assembly configured to sense the movement of the movable part relative to the fixed assembly. The position-sensing assembly includes a sensing element and a sensing magnet. The sensing element is fixedly disposed on the fixed assembly. The sensing magnet is fixedly disposed on the movable part. When viewed along the main axis, a connecting line between the center of the sensing element and the center of the transmission element does not pass through the optical element. When viewed along the main axis, a connecting line between the center of the sensing element and the center of the second supporting element does not pass through the optical element.

According to some embodiments, the optical element driving mechanism further includes a blocking assembly configured to limit the range of motion of the movable part. The blocking assembly includes a first blocking element and a second blocking element. When the movable part is located in a first extreme position, the first blocking element is in contact with the second blocking element. The blocking assembly further includes a third blocking element. When the movable part is located in a second extreme position, the third blocking element is configured to be in contact with the top wall.

According to some embodiments, when viewed in a direction perpendicular to the main axis, the first blocking element overlaps at least a portion of the second separating portion. When viewed in a direction perpendicular to the main axis, the second blocking element overlaps at least a portion of the second separating portion. When viewed in a direction perpendicular to the main axis, the first blocking element does not overlap the first separating portion. When viewed in a direction perpendicular to the main axis, the second blocking element does not overlap the first separating portion.

The present disclosure provides an optical element driving mechanism which includes a fixed assembly, a movable part, and a driving assembly. The movable part is movable relative to the fixed assembly, and the driving assembly is configured to drive the movable part to move relative to the fixed assembly. Moreover, the optical element driving mechanism further includes an accommodation space configured to accommodate at least a portion of the driving assembly.

In some embodiments, the optical element driving mechanism further includes a first guiding assembly and a second guiding assembly configured to guide the movement of the movable part. The first guiding assembly and the second guiding assembly respectively have a first supporting element and a second supporting element, and each of them have a columnar structure (for example, a cylindrical structure) and pass through the movable part to guide the movement of the movable part.

In some embodiments, the first supporting element can be made of magnetically permeable material, and can act with the first stabilizing element to generate a first stabilizing force which is applied to the movable part, so as to avoid the problem of tilting of the movable part during movement. In addition, the second supporting element can be made of metal material, and the second supporting element is arranged adjacent to the transmission element. Based on this configuration, the problem that the movable part breaks the transmission element when the optical element driving mechanism is impacted can be avoided. That is, the second supporting element can absorb the impact force received by the movable part to protect the transmission element.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 100 according to an embodiment of the present disclosure.

FIG. 2 is an exploded diagram of the optical element driving mechanism 100 according to an embodiment of the present disclosure.

FIG. 3 is a cross-sectional view of the optical element driving mechanism 100 along line A-A in FIG. 1 according to an embodiment of the present disclosure.

FIG. 4 is a top view of a partial structure of the optical element driving mechanism 100 according to an embodiment of the present disclosure.

FIG. 5 is an enlarged top view of a partial structure of the optical element driving mechanism 100 according to an embodiment of the present disclosure.

FIG. 6 is a three-dimensional cross-section view of the optical element driving mechanism 100 along the line B-B in FIG. 4 according to an embodiment of the present disclosure.

FIG. 7 is an enlarged top view of a partial structure of the optical element driving mechanism 100 according to an embodiment of the present disclosure.

FIG. 8 is a cross-sectional view of the optical element driving mechanism 100 along the line C-C in FIG. 1 according to an embodiment of the present disclosure.

FIG. 9 is a diagram illustrating that the movable part 108 moves and contacts the base 112 according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

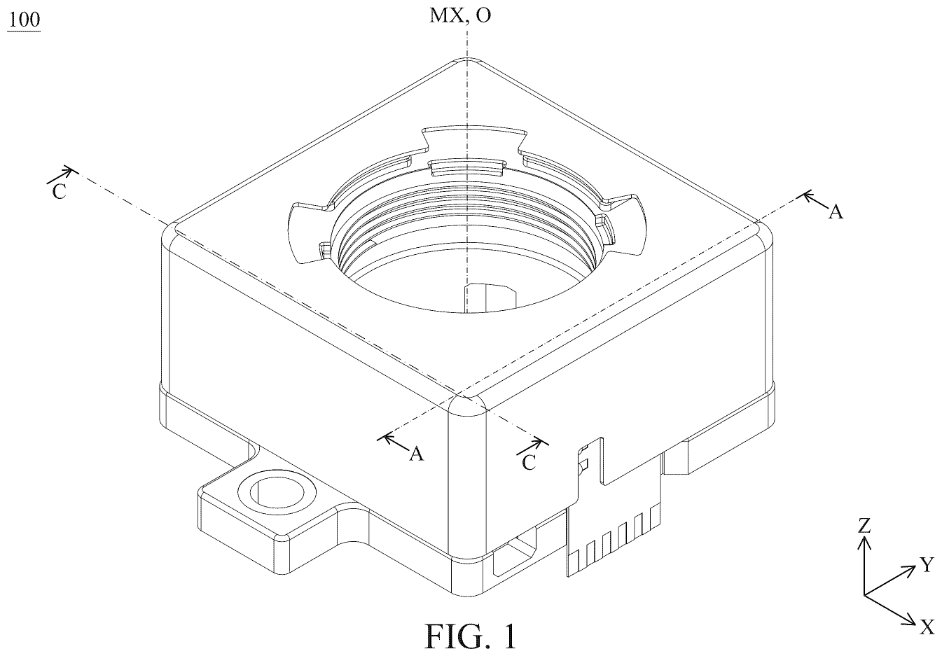

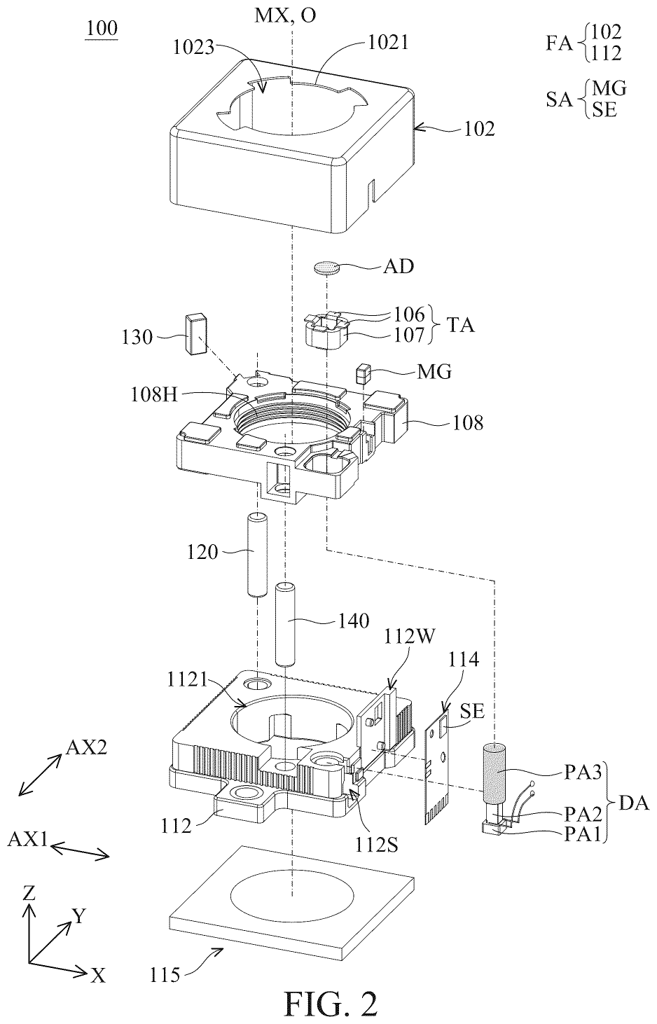

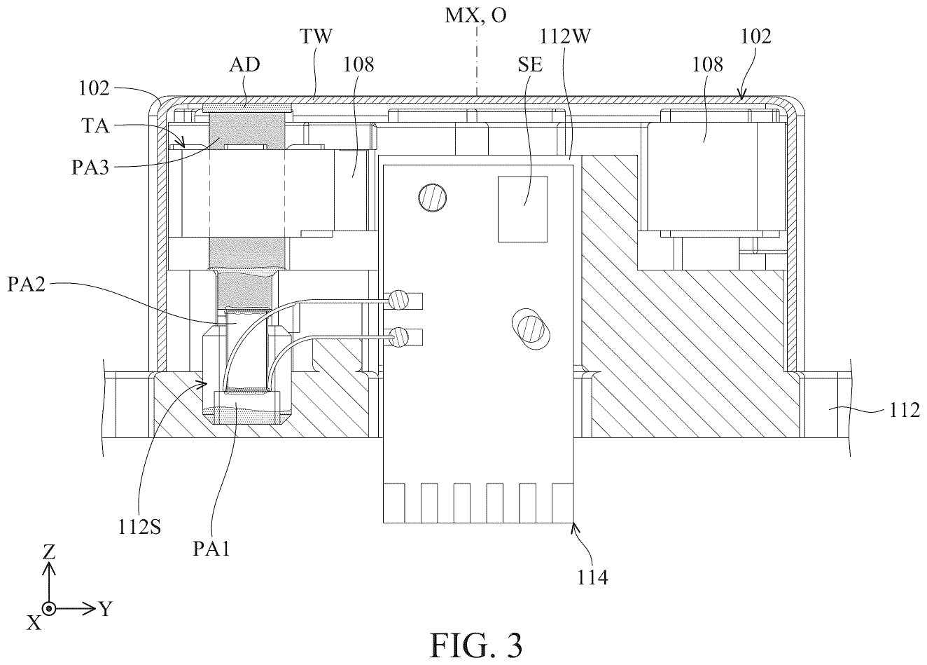

Please refer to FIG. 1 to FIG. 3. FIG. 1 is a schematic diagram of an optical element driving mechanism 100 according to an embodiment of the present disclosure, FIG. 2 is an exploded diagram of the optical element driving mechanism 100 according to an embodiment of the present disclosure, and FIG. 3 is a cross-sectional view of the optical element driving mechanism 100 along line A-A in FIG. 1 according to an embodiment of the present disclosure. The optical element driving mechanism 100 can be an optical camera system and can be configured to hold and drive an optical element (such a camera lens, not shown in figures). The optical element driving mechanism 100 can be installed in various electronic devices or portable electronic devices, such as a smartphone, for allowing a user to perform the image capturing function. In this embodiment, the optical element driving mechanism 100 can be with an auto-focusing (AF) function, but it is not limited thereto. In other embodiments, the optical element driving mechanism 100 can also perform the functions of auto-focusing and optical image stabilization (OIS).

In this embodiment, the optical element driving mechanism 100 may include a fixed assembly FA, a movable part 108, and a driving assembly DA. The movable part 108 may have an opening 108H and is configured to connect and hold the aforementioned optical element (such as an optical lens, not shown in the figures), and the movable part 108 is movable relative to the fixed assembly FA. The driving assembly DA is configured to drive the movable part 108 to move relative to the fixed assembly FA.

In this embodiment, as shown in FIG. 2, the fixed assembly FA includes a casing 102 and a base 112. The casing 102 has a hollow structure, and a casing opening 1021 is formed on it. A base opening 1121 is formed on the base 112, the center of the casing opening 1021 corresponds to an optical axis O of the optical element, and the base opening 1121 corresponds to a photosensitive assembly 115 which is disposed below the base 112. External light can enter the casing 102 through the casing opening 1021 and to be received by the aforementioned photosensitive assembly 115 after passing through the optical element and the base opening 1121 so as to generate a digital image signal. The photosensitive assembly 115 may, for example, be an image sensor, but it is not limited thereto.

Furthermore, the casing 102 and the base 112 are arranged along a main axis MX, and the casing 102 is disposed on the base 112. The main axis MX can overlap or be parallel to the optical axis O. The casing 102 may have an accommodation space 1023 for accommodating components such as the movable part 108 and the driving assembly DA, and so on.

For example, the optical element driving mechanism 100 may further include a circuit assembly 114 which is fixedly disposed a side wall 112W of the base 112, and a portion of the circuit assembly 114 is accommodated in the accommodation space 1023. The circuit assembly 114 may, for example, be a circuit board, but it is not limited thereto. For example, the circuit assembly 114 may be a flexible circuit board.

In this embodiment, as shown in FIG. 2 and FIG. 3, the driving assembly DA is electrically connected to the circuit assembly 114 and can be electrically connected to an external circuit, such as an external control circuit through the circuit assembly 114, so that the driving assembly DA can operate according to the control signal of the external circuit to drive the movable part 108 to move along the main axis MX or optical axis O.

In this embodiment, as shown in FIG. 2, the optical element driving mechanism 100 may further include an accommodation space 112S configured to receive at least a portion of the driving assembly DA. Specifically, as shown in FIG. 2 and FIG. 3, the driving assembly DA may include an enhancing element PA1, a driving element PA2, a transmission element PA3 and a central assembly TA. The transmission element PA3 can have a long strip-shaped structure (such as a column structure), extending along the main axis MX, and the transmission element PA3 may be made of a carbon material, but they are not limited thereto.

The enhancing element PA1 can be, for example, a counterweight, but it is not limited thereto. In other embodiments, the enhancing element PA1 can also be a spring sheet. The driving element PA2 may have a piezoelectric unit, such as a piezoelectric element, fixedly connected between the enhancing element PA1 and the transmission element PA3. In this embodiment, the driving element PA2 is made of a ceramic material, but it is not limited thereto.

The driving element PA2 is configured to generate a driving force, the enhancing element PA1 corresponds to the driving element PA2 to enhance the intensity of the driving force, and the transmission element PA3 is configured to transmit the driving force. The aforementioned driving force can be transmitted to the movable part 108 through the transmission element PA3 to drive the movable part 108 to move along the main axis MX so as to achieve the purpose of autofocus.

Furthermore, the central assembly TA corresponds to the transmission element PA3, and the central assembly TA is disposed between the transmission element PA3 and the movable part 108. As shown in FIG. 2 and FIG. 3, the transmission element PA3 passes through the central assembly TA and the movable part 108, and the movable part 108 clamps the transmission element PA3 through the central assembly TA. Therefore, the driving force can be transmitted to the movable part 108 through the transmission element PA3 and the central assembly TA in sequence.

As shown in FIG. 3, the optical element driving mechanism 100 further includes an adhesive element AD, and the driving assembly DA is connected to the casing 102 of the fixed assembly FA through the adhesive element AD. Specifically, the adhesive element AD is in direct contact with a top wall TW of the casing 102.

In this embodiment, the adhesive element AD may be elastic glue, such as gel, but it is not limited thereto. Based on this configuration, while the driving assembly DA is fixed, the operation of the transmission element PA3 will not be affected.

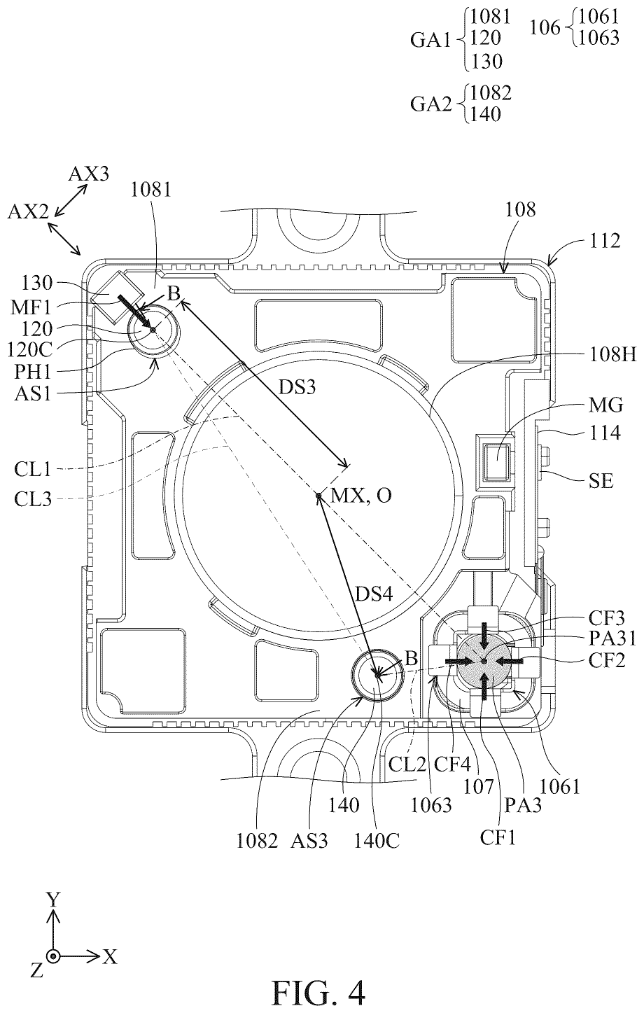

Next, please continue to refer to FIG. 2 to FIG. 4. FIG. 4 is a top view of a partial structure of the optical element driving mechanism 100 according to an embodiment of the present disclosure. As shown in FIG. 2, the central assembly TA may include a contact assembly 106 and a clamping member 107, and the contact assembly 106 corresponds to the transmission element PA3 of the driving assembly DA and contacts the transmission element PA3.

As shown in FIG. 3 and FIG. 4, at least a portion of the contact assembly 106 is located between the clamping member 107 and the transmission element PA3, and the contact assembly 106 may include two contact members 1061 and 1063. In this embodiment, the contact members 1061 and 1063 can be metal spring sheets, for example, and the clamping member 107 can be a rubber sleeve, for example, but they are not limited thereto.

In this embodiment, the clamping member 107 applies clamping force to the two contact members 1061 and 1063. As shown in FIG. 4, the clamping member 107 is configured to apply a first clamping force CF1 and a second clamping force CF2 to the transmission element PA3. Specifically, because the clamping member 107 clamps the transmission element PA3 through the contact member 1061, the clamping member 107 also applies the first clamping force CF1 and the second clamping force CF2 to the contact member 1061 of the contact assembly 106.

The directions of the first clamping force CF1 and the second clamping force CF2 are different. Similarly, the clamping member 107 also applies a third clamping force CF3 and a fourth clamping force CF4 to the contact member 1063 of the contact assembly 106, and the directions of the third clamping force CF3 and the fourth clamping force CF4 are different.

Please continue to refer to FIG. 2 to FIG. 4. In this embodiment, as shown in FIG. 3, because the driving assembly DA is disposed on the left side of the movable part 108, when the driving assembly DA drives the movable part 108 to move along the main axis MX, the right part of the movable part 108 may be tilted toward the base 112, resulting in unclear images.

In order to avoid the above situation, the optical element driving mechanism 100 may further include a first guiding assembly GA1 to avoid the problem of tilting of the movable part 108 during movement. The first guiding assembly GA1 is configured to guide the movable part 108 to move relative to the fixed assembly FA.

In this embodiment, as shown in FIGS. 2 and 4, the first guiding assembly GA1 may include a first stabilizing element 130, a first supporting element 120 and a first corresponding element 1081. The first stabilizing element 130 may have a magnetic material, such as a magnet, but it is not limited thereto. Correspondingly, the first supporting element 120 has a magnetically conductive material, such as a magnetically conductive metal material, but it is not limited thereto.

The first stabilizing element 130 is configured to react with the first supporting element 120 to generate a first stabilizing force MF1 to the movable part 108, and the first stabilizing force MF1 can drive the movable part 108 toward the first supporting element 120 to increase the friction between the movable part 108 and the first supporting element 120.

Based on such a design, the friction can avoid the aforementioned tilting problem of the movable part 108 during movement, and this friction will not affect the smoothness of the movable part 108 when moving along the main axis MX.

In addition, as shown in FIG. 4, the first clamping force CF1 is, for example, parallel to the Y-axis, the second clamping force CF2 is, for example, parallel to the X-axis, and the first stabilizing force MF1 is not parallel to the X-axis and the Y-axis. For example, if a center PA31 of the transmission element PA3 is defined as the origin, the angle between the first clamping force CF1 or the second clamping force CF2 and the first stabilizing force MF1 exceeds 90 degrees, such as between 125 degrees and 140 degrees, but it is not limited thereto.

The first stabilizing force MF1 is a magnetic attraction force, that is, the first stabilizing force MF1 belongs to the non-contact force, and the first clamping force CF1 and the second clamping force CF2 belong to the mechanical forces.

In addition, when viewed along the main axis MX, a connecting line CL1 between a center 120C of the first supporting element 120 and the center PA31 of the transmission element PA3 passes through the optical element, such as passing through the optical axis O, but it is not limited thereto.

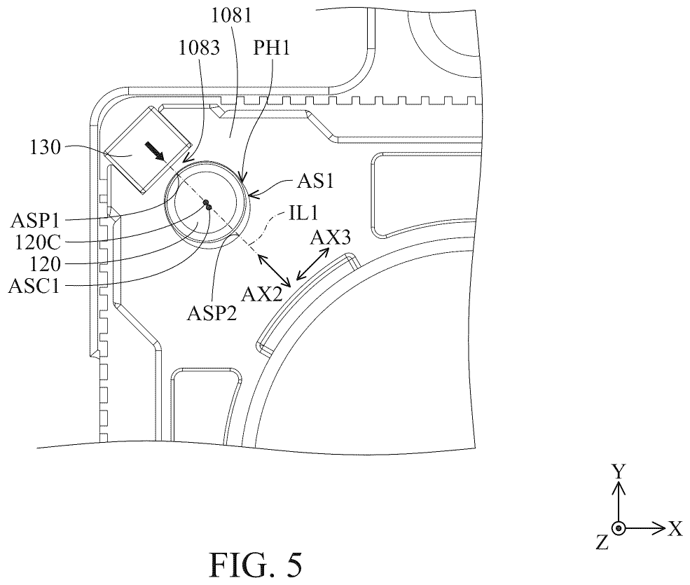

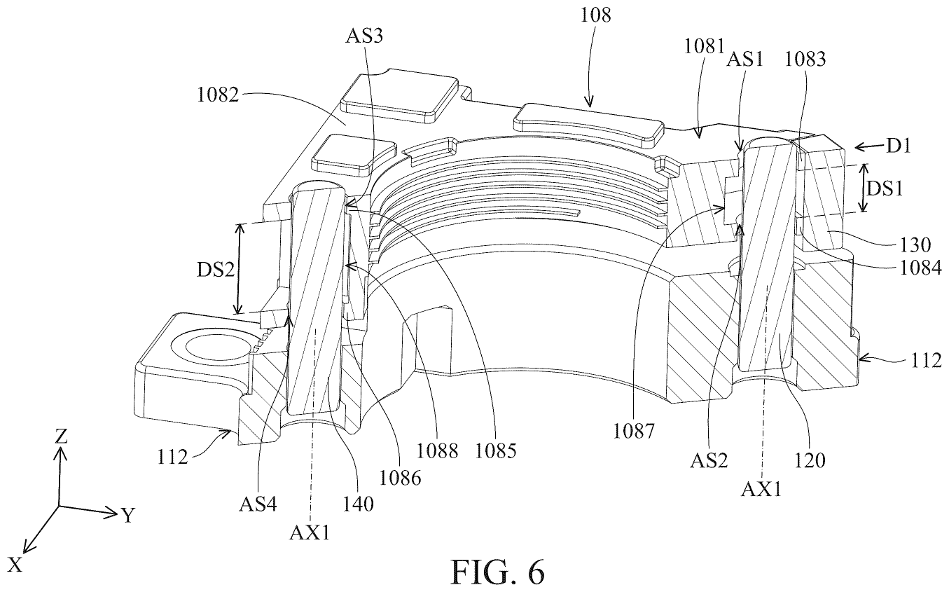

Next, please continue to refer to FIG. 2 to FIG. 6. FIG. 5 is an enlarged top view of a partial structure of the optical element driving mechanism 100 according to an embodiment of the present disclosure, and FIG. 6 is a three-dimensional cross-section view of the optical element driving mechanism 100 along the line B-B in FIG. 4 according to an embodiment of the present disclosure.

As shown in FIG. 5 and FIG. 6, the first corresponding element 1081 is part of the movable part 108, and the first corresponding element 1081 can have a first accommodation space AS1 configured to accommodate at least a portion of the first supporting element 120.

Furthermore, the first corresponding element 1081 may further include a first contact portion 1083 configured to contact the first supporting element 120. As shown in FIG. 6, the first supporting element 120 may have a long strip-shaped structure, and the first supporting element 120 extends along a first axis AX1.

As shown in FIG. 5, when viewed along the first axis AX1 (the Z-axis), the center 120C of the first supporting element 120 does not overlap the center ASCI of the first accommodation space AS1. Specifically, when viewed along the first axis AX1, the minimum distance between a close portion ASP1 of the first accommodation space AS1 and the first supporting element 120 is less than the minimum distance between an avoiding portion ASP2 of the first accommodation space AS1 and the first supporting element 120.

The first accommodation space AS1 is formed by a performance PH1 of the movable part 108, and the close portion ASP1 and the avoiding portion ASP2 can be the inner wall surfaces of the performance PH1, but they are not limited thereto.

As shown in FIG. 5, when viewed along the first axis AX1, the close portion ASP1 and the avoiding portion ASP2 can define a first imaginary line IL1, which passes through the close portion ASP1 and the avoiding portion ASP2, and the first imaginary line IL1 is parallel to first stabilizing force MF1.

When viewed along the first axis AX1, the first accommodation space AS1 may have a long strip-shaped structure. Specifically, the first accommodation space AS1 may be ellipse. When viewed along the first axis AX1, the extending direction of the first accommodation space AS1 (the longitudinal axis of the ellipse) is parallel to the first stabilizing force MF1.

Next, as shown in FIG. 6, the first corresponding element 1081 may further include a second accommodation space AS2 configured to accommodate at least a portion of the first supporting element 120, and the first accommodation space AS1 and the second accommodation space AS2 are arranged along the first axis AX1.

Similarly, the first corresponding element 1081 may have a second contact portion 1084 configured to contact the first supporting element 120, and the first contact portion 1083 and the second contact portion 1084 may also be arranged along the first axis AX1.

In addition, the first corresponding element 1081 may further have a first separating portion 1087 located between the first accommodation space AS1 and the second accommodation space AS2, and the first separating portion 1087 is also located between the first contact portion 1083 and the second contact portion 1084. In this embodiment, the first separating portion 1087 can be the inner wall surface of the movable part 108 between the first accommodation space AS1 and the second accommodation space AS2 and does not contact the first supporting element 120.

In this embodiment, as shown in FIGS. 4 and 6, the optical element driving mechanism 100 may further include a second guiding assembly GA2 configured to guide the movable part 108 to move relative to the fixed assembly FA. The second guiding assembly GA2 may include a second supporting element 140 and a second corresponding element 1082.

The second corresponding element 1082 is also a portion of the movable part 108. That is, the first corresponding element 1081 and the second corresponding element 1082 are integrally formed as one piece. As shown in FIG. 4 and FIG. 6, the second corresponding element 1082 has a third accommodation space AS3 configured to accommodate at least a portion of the second supporting element 140.

Similarly, the second corresponding element 1082 has a third contact portion 1085 configured to contact the second supporting element 140. The second supporting element 140 has a long strip-shaped structure, and the second supporting element 140 extends along the first axis AX1.

In this embodiment, the first stabilizing element 130 is fixedly connected to the movable part 108, the first supporting element 120 is fixedly connected to the base 112 of the fixed assembly FA, and the second supporting element 140 is fixedly connected to the base 112 of the fixed assembly FA.

Similarly, as shown in FIG. 6, the second corresponding element 1082 may further include a fourth accommodation space AS4 configured to accommodate at least a portion of the second supporting element 140, and the third accommodation space AS3 and the fourth accommodation space AS4 are arranged along the first axis AX1.

Furthermore, the second corresponding element 1082 may further have a fourth contact portion 1086 configured to contact the second supporting element 140, and the third contact portion 1085 and the fourth contact portion 1086 are arranged along the first axis AX1.

Similarly, the second corresponding element 1082 has a second separating portion 1088 located between the third accommodation space AS3 and the fourth accommodation space AS4, and the second separating portion 1088 is also located between the third contact portion 1085 and the fourth contact portion 1086. In this embodiment, the second separating portion 1088 does not contact the second supporting element 140.

As shown in FIG. 6, the shortest distance DS1 between the first accommodation space AS1 and the second accommodation space AS2 is different from the shortest distance DS2 between the third accommodation space AS3 and the fourth accommodation space AS4.

Specifically, the shortest distance DS1 between the first accommodation space AS1 and the second accommodation space AS2 is less than the shortest distance DS2 between the third accommodation space AS3 and the fourth accommodation space AS4.

As shown in FIG. 6, when viewed in a direction perpendicular to the first axis AX1 (for example, viewed in a first direction D1), at least a portion of the first accommodation space AS1 overlaps the third accommodation space AS3.

On the other hand, when viewed in the direction perpendicular to the first axis AX1 (for example, viewed in the first direction D1), the second accommodation space AS2 does not overlap the fourth accommodation space AS4.

Next, return to FIG. 4 and FIG. 5. In this embodiment, the first axis AX1 may be parallel to the main axis MX, but it is not limited thereto. As shown in FIG. 4, when viewed along the first axis AX1, the shortest distance DS3 between the center 120C of the first supporting element 120 and the center of the optical element (such as optical axis O) is different from the shortest distance DS4 between a center 140C of the second supporting element 140 and the center of the optical element.

Specifically, when viewed along the first axis AX1, the shortest distance DS3 between the center 120C of the first supporting element 120 and the center of the optical element is greater than the shortest distance DS4 between the center 140C of the second supporting element 140 and the center of the optical element.

Furthermore, as shown in FIG. 4, when viewed along the main axis MX, a connecting line CL2 between the center 140C of the second supporting element 140 and the center PA31 of the transmission element PA3 does not pass through the optical element. That is, the connecting line CL2 does not pass through the opening 108H.

In addition, when viewed along the main axis MX, a connecting line CL3 between the center 120C of the first supporting element 120 and the center 140C of the second supporting element 140 passes through the optical element. That is, the connecting line CL3 passes through the opening 108H.

It is worth noting that the first supporting element 120 is closer to the optical axis O than the first stabilizing element 130, and the second supporting element 140 is closer to the optical axis O than the transmission element PA3. Based on this configuration, not only can the overall stability be effectively improved, but also through special space design, the required volume of the optical element driving mechanism 100 can be reduced, thereby achieving the purpose of miniaturization.

Furthermore, as shown in FIG. 5, when viewed along the first axis AX1, the first accommodation space AS1 has a long strip-shaped structure which extends along a second axis AX2. That is, the longitudinal axis of the first accommodation space AS1 (the ellipse) overlaps the second axis AX2.

In this embodiment, the optical element driving mechanism 100 can further define a third axis AX3, and the third axis AX3, the first axis AX1 and the second axis AX2 are perpendicular to each other.

As shown in FIG. 5, when viewed along the first axis AX1 or the main axis MX, the first stabilizing element 130 and the first supporting element 120 are arranged along the second axis AX2.

When viewed along the first axis AX1, the maximum size of the first accommodation space AS1 on the second axis AX2 and the maximum size of the first accommodation space AS1 on the third axis AX3 may have a first ratio.

Similarly, when viewed along the first axis AX1, as shown in FIG. 4, the maximum size of the third accommodation space AS3 on the second axis AX2 and the maximum size of the third accommodation space AS3 on the third axis AX3 may have a second ratio.

The first ratio is different from the second ratio. Specifically, the first ratio is greater than the second ratio. In this embodiment, because the first accommodation space AS1 has an elliptical structure, the first ratio is greater than 1, and the second accommodation space AS2 has a circular structure, so that the second ratio may be 1.

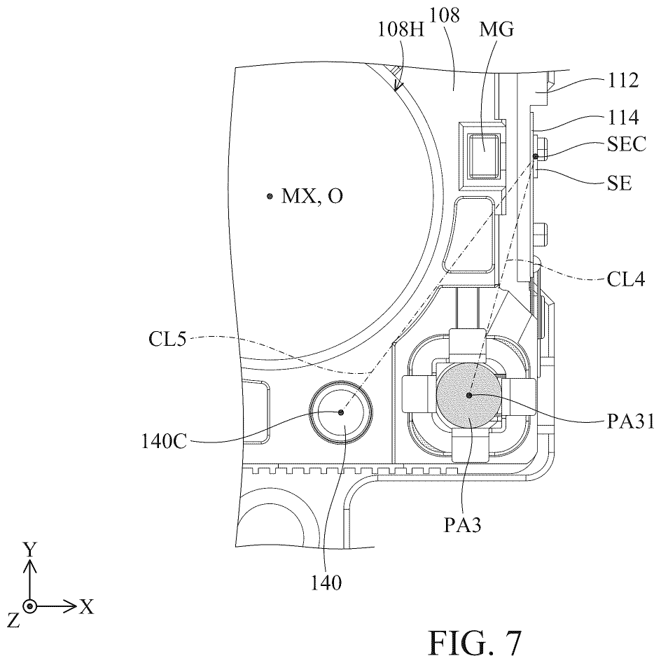

Next, please refer to FIG. 2 and FIG. 7. FIG. 7 is an enlarged top view of a partial structure of the optical element driving mechanism 100 according to an embodiment of the present disclosure. In this embodiment, the optical element driving mechanism 100 further includes a position-sensing assembly SA configured to sense the movement of the movable part 108 relative to the fixed assembly FA.

As shown in FIG. 7, the position-sensing assembly SA may include a sensing element SE and a sensing magnet MG. The sensing element SE is fixedly disposed on the circuit assembly 114 on the base 112 of the fixed assembly FA, and the sensing magnet MG is fixedly disposed on the movable part 108. The sensing element SE can be, for example, a Hall sensor or a tunnel magneto resistance sensor (the TMR sensor), and the sensing magnet MG can be, for example, a multipole magnet, but they are not limited thereto.

When viewed along the main axis MX, a connecting line CLA between a center SEC of the sensing element SE and the center PA31 of the transmission element PA3 does not pass through the optical element. That is, the connecting line CL4 does not pass through the opening 108H.

Furthermore, when viewed along the main axis MX, a connecting line CL5 between the center SEC of the sensing element SE and the center 140C of the second supporting element 140 does not pass through the optical element. That is, the connecting line CL5 does not pass through the opening 108H.

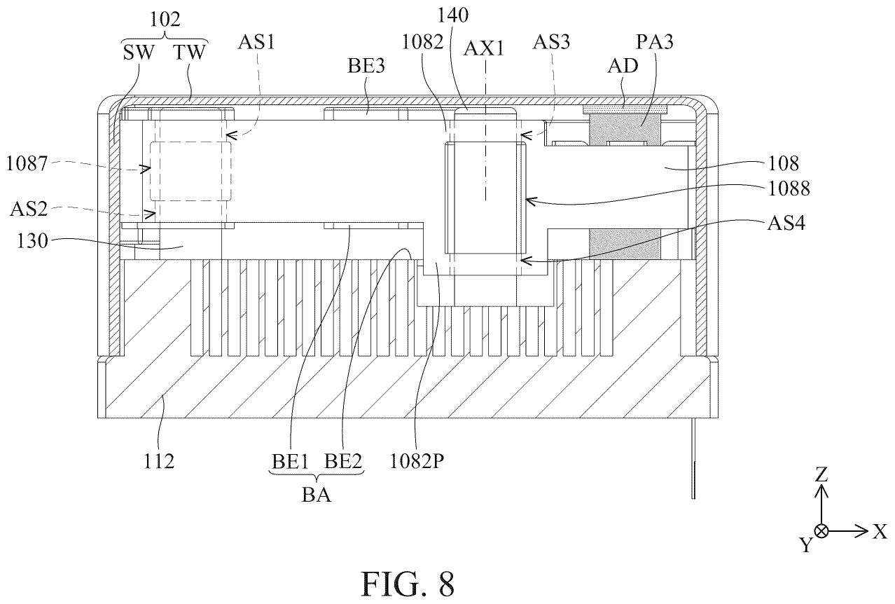

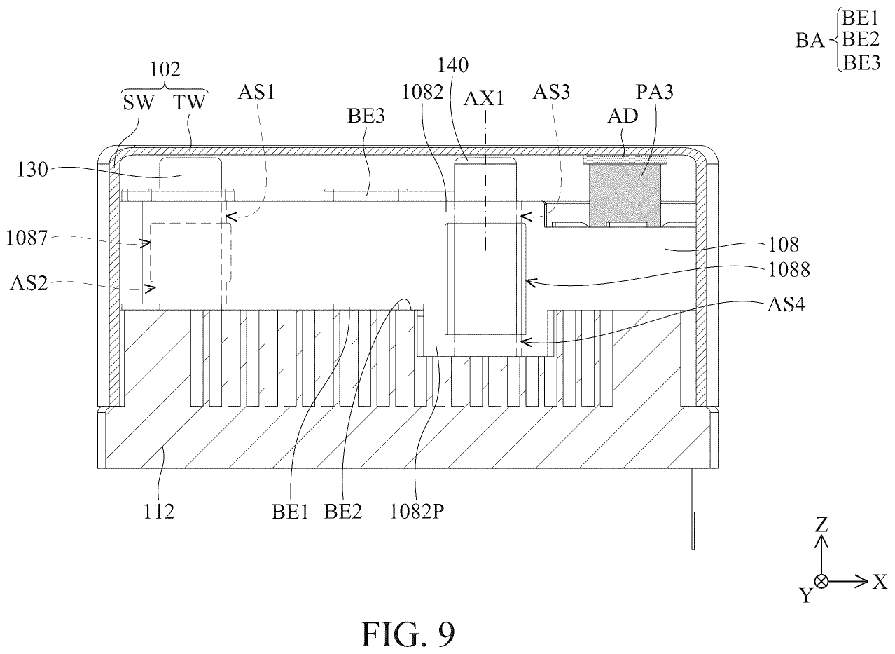

Next, please refer to FIG. 8 to FIG. 9. FIG. 8 is a cross-sectional view of the optical element driving mechanism 100 along the line C-C in FIG. 1 according to an embodiment of the present disclosure, and FIG. 9 is a diagram illustrating that the movable part 108 moves and contacts the base 112 according to an embodiment of the present disclosure.

As shown in FIG. 8, casing 102 has the aforementioned top wall TW and a side wall SW. The top wall TW is connected to the side wall SW, and the top wall TW has a plate-shaped structure, which is not parallel to the first axis AX1, such as perpendicular to the first axis AX1.

As shown in FIG. 8, the first accommodation space AS1 is closer to the top wall TW than the second accommodation space AS2, and the third accommodation space AS3 is closer to the top wall TW than the fourth accommodation space AS4.

Furthermore, in this embodiment, the second corresponding element 1082 further has a protruding portion 1082P which extends toward the base 112. The base 112 may be made of plastic material, and the fourth accommodation space AS4 is located at the protruding portion 1082P.

Next, as shown in FIG. 8 and FIG. 9, in this embodiment, the optical element driving mechanism 100 may further include a blocking assembly BA configured to limit the movement range of the movable part 108. The blocking assembly BA may include a first blocking element BE1 and a second blocking element BE2.

The first blocking element BE1 may be a protrusion at the bottom of the movable part 108, and the second blocking element BE2 may be located at the base 112 (such as the top surface of the base 112). As shown in FIG. 9, when the movable part 108 is located in a first extreme position, the first blocking element BE1 is in contact with the second blocking element BE2.

As shown in FIG. 9, when viewed in the direction perpendicular to the main axis MX (for example, viewed along the X-axis), the first blocking element BE1 overlaps at least a portion of the second separating portion 1088, and when viewed in the direction perpendicular to the main axis MX, the second blocking element BE2 overlaps at least a portion of the second separating portion 1088.

On the other hand, when viewed in the direction perpendicular to the main axis MX, the first blocking element BE1 does not overlap the first separating portion 1087, and when viewed in the direction perpendicular to the main axis MX, the second blocking element BE2 does not overlap the first separating portion 1087.

Furthermore, as shown in FIG. 8, when the movable part 108 moves back to a second extreme position in FIG. 8, the first blocking element BE1 does not contact the second blocking element BE2. In addition, the blocking assembly BA may further include a third blocking element BE3 located on the top of the movable part 108, and when the movable part 108 is located in the second extreme position in FIG. 8, the third blocking element BE3 is configured to be in contact with the top wall TW so as to limit the range of motion of movable part 108.

In conclusion, the present disclosure provides an optical element driving mechanism 100 which includes a fixed assembly FA, a movable part 108, and a driving assembly DA. The movable part 108 is movable relative to the fixed assembly FA, and the driving assembly DA is configured to drive the movable part 108 to move relative to the fixed assembly FA. Moreover, the optical element driving mechanism 100 further includes an accommodation space 112S configured to accommodate at least a portion of the driving assembly DA.

In some embodiments, the optical element driving mechanism 100 further includes a first guiding assembly GA1 and a second guiding assembly GA2 configured to guide the movement of the movable part 108. The first guiding assembly GA1 and the second guiding assembly GA2 respectively have a first supporting element 120 and a second supporting element 140, and each of them have a columnar structure (for example, a cylindrical structure) and pass through the movable part 108 to guide the movement of the movable part 108.

In some embodiments, the first supporting element 120 can be made of magnetically permeable material, and can act with the first stabilizing element 130 to generate a first stabilizing force MF1 which is applied to the movable part 108, so as to avoid the problem of tilting of the movable part 108 during movement. In addition, the second supporting element 140 can be made of metal material, and the second supporting element 140 is arranged adjacent to the transmission element PA3. Based on this configuration, the problem that the movable part 108 breaks the transmission element PA3 when the optical element driving mechanism 100 is impacted can be avoided. That is, the second supporting element 140 can absorb the impact force received by the movable part 108 to protect the transmission element PA3.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly, having a main axis;
a movable part, configured to be connected to an optical element, wherein the movable part is movable relative to the fixed assembly; and
a driving assembly, configured to drive the movable part to move relative to the fixed assembly.

2. The optical element driving mechanism as claimed in claim 1, wherein the optical element driving mechanism further includes a first guiding assembly configured to guide movement of the movable part relative to the fixed assembly;
the first guiding assembly includes a first stabilizing element, a first supporting element and a first corresponding element;
the first stabilizing element has a magnetic material;
the first supporting element has a magnetically conductive material;
the first stabilizing element is configured to generate a first stabilizing force to the movable part; and
the first stabilizing force drives the movable part toward the first supporting element.

3. The optical element driving mechanism as claimed in claim 2, wherein the first corresponding element has a first accommodation space configured to accommodate at least a portion of the first supporting element;
the first corresponding element further includes a first contact portion configured to contact the first supporting element;
the first supporting element has a long strip-shaped structure;
the first supporting element extends along a first axis; and
when viewed along the first axis, a center of the first supporting element does not overlap a center of the first accommodation space.

4. The optical element driving mechanism as claimed in claim 3, wherein
when viewed along the first axis, a minimum distance between a close portion of the first accommodation space and the first supporting element is less than a minimum distance between an avoiding portion of the first accommodation space and the first supporting element;
when viewed along the first axis, the close portion and the avoiding portion define a first imaginary line which passes through the close portion and the avoiding portion;
the first imaginary line is parallel to the first stabilizing force;
when viewed along the first axis, the first accommodation space has a long strip-shaped structure; and
when viewed along the first axis, an extending direction of the first accommodation space is parallel to the first stabilizing force.

5. The optical element driving mechanism as claimed in claim 4, wherein
the first corresponding element further includes a second accommodation space configured to accommodate at least a portion of the first supporting element;
the first accommodation space and the second accommodation space are arranged along the first axis;
the first corresponding element further has a second contact portion configured to contact the first supporting element;
the first contact portion and the second contact portion are arranged along the first axis;
the first corresponding element further has a first separating portion located between the first accommodation space and the second accommodation space;
the first separating portion is located between the first contact portion and the second contact portion; and
the first separating portion does not contact the first supporting element.

6. The optical element driving mechanism as claimed in claim 5, wherein
the optical element driving mechanism further includes a second guiding assembly configured to guide the movement of the movable part relative to the fixed assembly;
the second guiding assembly includes a second supporting element and a second corresponding element;
the second corresponding element has a third accommodation space configured to accommodate at least a portion of the second supporting element;
the second corresponding element has a third contact portion configured to contact the second supporting element;
the second supporting element has a long strip-shaped structure; and
the second supporting element extends along the first axis.

7. The optical element driving mechanism as claimed in claim 6, wherein
the second corresponding element further includes a fourth accommodation space configured to accommodate at least a portion of the second supporting element; and
the third accommodation space and the fourth accommodation space are arranged along the first axis.

8. The optical element driving mechanism as claimed in claim 7, wherein
the second corresponding element further has a fourth contact portion configured to contact the second supporting element;
the third contact portion and the fourth contact portion are arranged along the first axis;
the second corresponding element further has a second separating portion located between the third accommodation space and the fourth accommodation space;
the second separating portion is located between the third contact portion and the fourth contact portion;
the second separating portion does not contact the second supporting element;
a shortest distance between the first accommodation space and the second accommodation space is different from a shortest distance between the third accommodation space and the fourth accommodation space; and
the shortest distance between the first accommodation space and the second accommodation space is less than the shortest distance between the third accommodation space and the fourth accommodation space.

9. The optical element driving mechanism as claimed in claim 8, wherein
when viewed along the first axis, a shortest distance between the center of the first supporting element and a center of the optical element is different from a shortest distance between a center of the second supporting element and the center of the optical element; and
when viewed along the first axis, the shortest distance between the center of the first supporting element and the center of the optical element is greater than the shortest distance between the center of the second supporting element and the center of the optical element.

10. The optical element driving mechanism as claimed in claim 9, wherein
when viewed in a direction perpendicular to the first axis, at least a portion of the first accommodation space overlaps the third accommodation space; and
when viewed in a direction perpendicular to the first axis, the second accommodation space does not overlap the fourth accommodation space.

11. The optical element driving mechanism as claimed in claim 10, wherein
the fixed assembly includes a casing and a base;
the casing has a top wall and a side wall;
the top wall is connected to the side wall;
the top wall has a plate-shaped structure which is not parallel to the first axis;
the first accommodation space is closer to the top wall than the second accommodation space; and
the third accommodation space is closer to the top wall than the fourth accommodation space.

12. The optical element driving mechanism as claimed in claim 11, wherein
the second corresponding element has a protruding portion which extends toward the base;
the base has a plastic material;
the fourth accommodation space is located at the protruding portion;
the first corresponding element and the second corresponding element are integrally formed as one piece;
the first stabilizing element is fixedly connected to the movable part;
the first supporting element is fixedly connected to the fixed assembly; and
the second supporting element is fixedly connected to the fixed assembly.

13. The optical element driving mechanism as claimed in claim 12, wherein
the driving assembly includes a driving element, a transmission element and an enhancing element;
the driving element is fixedly connected between the transmission element and the enhancing element;
the driving element is configured to generate a driving force;
the driving element has a piezoelectric unit;
the transmission element is configured to transmit the driving force;
the enhancing element is configured to enhance the driving force; and
the transmission element has a long strip-shaped structure which extends along the main axis.

14. The optical element driving mechanism as claimed in claim 13, wherein
the optical element driving mechanism further includes a central assembly, and the driving force is transmitted to the movable part through the central assembly;
the central assembly includes a clamping member and a contact assembly;
the clamping member is configured to apply a first clamping force and a second clamping force to the transmission element;
at least a portion of the contact assembly is located between the clamping member and the transmission element;
the clamping member applies the first clamping force and the second clamping force to the contact assembly; and
directions of the first clamping force and the second clamping force are different.

15. The optical element driving mechanism as claimed in claim 14, wherein
when a center of the transmission element is defined as the origin, an angle between the first clamping force or the second clamping force and the first stabilizing force exceeds 90 degrees;
when viewed along the main axis, a connecting line between the center of the first supporting element and the center of the transmission element passes through the optical element;
the first stabilizing force is a non-contact force; and
the first clamping force and the second clamping force belong to mechanical forces.

16. The optical element driving mechanism as claimed in claim 15, wherein
when viewed along the main axis, a connecting line between the center of the second supporting element and the center of the transmission element does not pass through the optical element;
when viewed along the main axis, a connecting line between the center of the first supporting element and the center of the second supporting element passes through the optical element;
when viewed along the first axis, the first accommodation space has a long strip-shaped structure which extends along a second axis;
the optical element driving mechanism further defines a third axis;
the third axis, the first axis and the second axis are perpendicular to each other; and
when viewed along the first axis, the first stabilizing element and the first supporting element are arranged along the second axis.

17. The optical element driving mechanism as claimed in claim 16, wherein
when viewed along the first axis, a maximum size of the first accommodation space on the second axis and a maximum size of the first accommodation space on the third axis have a first ratio;
when viewed along the first axis, a maximum size of the third accommodation space on the second axis and a maximum size of the third accommodation space on the third axis have a second ratio;
the first ratio is different from the second ratio; and
the first ratio is greater than the second ratio.

18. The optical element driving mechanism as claimed in claim 17, wherein
the optical element driving mechanism further includes a position-sensing assembly configured to sense the movement of the movable part relative to the fixed assembly;
the position-sensing assembly includes a sensing element and a sensing magnet;
the sensing element is fixedly disposed on the fixed assembly;
the sensing magnet is fixedly disposed on the movable part;
when viewed along the main axis, a connecting line between a center of the sensing element and the center of the transmission element does not pass through the optical element; and
when viewed along the main axis, a connecting line between the center of the sensing element and the center of the second supporting element does not pass through the optical element.

19. The optical element driving mechanism as claimed in claim 18, wherein
the optical element driving mechanism further includes a blocking assembly configured to limit the range of motion of the movable part;
the blocking assembly includes a first blocking element and a second blocking element;
when the movable part is located in a first extreme position, the first blocking element is in contact with the second blocking element;
the blocking assembly further includes a third blocking element; and
when the movable part is located in a second extreme position, the third blocking element is configured to be in contact with the top wall.

20. The optical element driving mechanism as claimed in claim 19, wherein
when viewed in a direction perpendicular to the main axis, the first blocking element overlaps at least a portion of the second separating portion;
when viewed in the direction perpendicular to the main axis, the second blocking element overlaps at least a portion of the second separating portion;
when viewed in a direction perpendicular to the main axis, the first blocking element does not overlap the first separating portion; and
when viewed in a direction perpendicular to the main axis, the second blocking element does not overlap the first separating portion.
